(19) United States
(12) Patent Application Publication
(10) Pub. No.: US 2009/0243145 A1
(43) Pub. Date: Oct. 1, 2009

(54) Method for producing cellulose acylate film

(75) Inventors: Masaru Sugiura, Kanagawa (JP); Fumio Kawamoto, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/792,948

(22) PCT Filed: Dec. 14, 2005
(86) PCT No.: PCT/JP2005/023423

§ 371 Date: Jun. 13, 2007

(30) Foreign Application Priority Data
Dec. 21, 2004 (JP) 2004-369473

(51) Int. Cl. B29C 39/00

(52) U.S. Cl. 264/217

(57) ABSTRACT

A casting film (24) is formed by casting a cellulose acylate solution (16) onto a cold drum (22) continuously running. The cellulose acylate solution (16) contains at most 0.01% of a compound which is extracted to a liquid incompatible with the water in a mixture of the water and the liquid. That is, at most 50 mg of the compound is contained in 100 g of cellulose acylate. In the cellulose acylate solution (16), a concentration C1 of Ca is at most 100 ppm, a proportion of the C1 to a concentration C2 of sulfuric acid satisfies the following formula: 0.5≦C1/C2≦1.5, and a concentration of Mg is in the range of 5 ppm to 50 ppm. Thereby, contamination of the surface of the cold drum (22) is prevented.

### TECHNICAL FIELD

The present invention relates to a method for producing a cellulose acylate film for optical application in a device such as a liquid crystal display or the like.

### BACKGROUND ART

Having high birefringence and retardation value, a cellulose acylate film is popularly used as a protective film in the polarizing filter of a liquid crystal display (LCD). The LCD with the cellulose acylate film can be thin and supplied at a low price in the market.

The cellulose acylate film is well-known to be produced by a melt-extrusion method which uses a polymer melted with heat, or a solution casting method which uses dope containing additives, particles, a solvent, and the polymers such as cellulose acylate. The solution casting method is generally employed, since it can produce the film with excellent optical property and planarity.

The solution casting method is used for producing a polymer film and comprises a casting process and a drying process. In the casting process a cellulose acylate solution containing the solvent and cellulose acylate as raw material of the film is cast onto a continually running support to form a casting film. In the drying process, which is after the casting film containing the solvent is peeled off from the support when it obtains a self-supporting property, the casting film is dried by volatilizing the solvent while advanced by a plurality of rollers.

The solution casting method is roughly divided into two types, an endless band type and a drum type, depending on a kind of the support onto which the cellulose acylate solution is cast. In the solution casting method of the endless band type, the cellulose acylate solution is prepared and cast onto an endless band, which is continuously running and used as the support, to form the casting film, and then the film containing the solvent is peeled off from the endless band and dried by volatilizing the solvent by a drying device. On the other hand, in the solution casting method of the drum type, the cellulose acylate solution is prepared and cast onto a cold drum, which is continually running and used as the support, and then the film containing the solvent is peeled off from the drum and dried by volatilizing the solvent by the drying device. With the help of the cold drum, the casting film can obtain the self-supporting property in a shorter time in the solution casting method of the drum type than the solution casting method of the endless band type. Accordingly, the time before peeling off the film can be substantially reduced, which results in speeding up a film producing process.

However, a surface of the drum is contaminated with the course of time and the film can be debased. If the film is debased, it is necessary to suspend the film producing process to clean the drum, which prolongs a manufacturing time and reduces productivity. Such a case can also happen to the endless band, though the contamination of a surface of the endless band is not worse than the drum.

In order to improve the productivity of the solution casting method for producing the cellulose acylate film, it is desired to prevent contamination of the surfaces of the supports such as the drum and the band.

An object of the present invention is to provide the solution casting method which is capable of improving the productivity of the cellulose acylate film by preventing contamination of the surface of the support.

### DISCLOSURE OF INVENTION

In order to achieve the object and other objects, a solution casting method of the present invention uses a cellulose acylate solution prepared with cellulose acylate having a small quantity of contaminating substance. The contamination of a surface of a support is thus prevented. The present invention is based on the results of the following analysis.

An analysis was carried out to identify the contaminating substance on the drum and to clarify the generating mechanism of the contaminating substance. As a result, it was found that the contaminating substance is mainly calcium salt generated by chemical bond of Ca²⁺ and compounds (hereinafter, referred to as the contamination precursors) to be extracted in a liquid incompatible with the water in the mixture of the liquid and the water. The contamination precursors are mainly fatty acid, fatty acid metal salt, and fatty acid alcohol, for example.

Cellulose acylate used for the cellulose acylate solution is usually produced by acetylating cellulose extracted from wood pulp, cotton linters or the like with an acylating agent. Although sulfuric acid is used as a catalyst to accelerate the acetylation, the cellulose acylate solution loses its property because a part of sulfuric acid causes hydrolysis of cellulose acylate. In order to prevent that, Ca(OH)₂ is generally added to cellulose acylate, such that Ca²⁺ in Ca(OH)₂ forms sulfate by reacting with sulfuric acid and weakens property of sulfuric acid as acid. However, it was found that calcium salt, formed by the reaction of Ca²⁺ and the contamination precursors in the cellulose acylate solution, contaminates the surface of the drum.

According to the present invention, a method for producing a cellulose acylate film comprises steps of preparing the cellulose acylate solution by dissolving cellulose acylate in a solvent, the cellulose acylate containing a compound at most 0.05% thereof to be extracted to a liquid incompatible with the water in a mixture of the liquid and the water, casting the cellulose acylate solution onto a support running continuously to form a casting film, peeling off the casting film as a film from the support, and drying the film by a drying device while the film is advanced.

Preferably, a concentration C1 of Ca in the cellulose acylate solution is at most 100 ppm, and more preferably at most 80 ppm. A proportion of the C1 to a concentration C2 of sulfuric acid in the cellulose acylate solution satisfies the following formulae: 0.5≦C1/C2≦1.5, and more preferably 0.5≦C1/C2≦1.0. A concentration of Mg in the cellulose acylate solution is preferably in the range of 5 ppm to 50 ppm, and more preferably in the range of 5 ppm to 30 ppm. In addition, cellulose acylate is obtained from pulp wood, and the total number of moles M1 of all sugar in cellulose acylate and the number of moles M2 of mannose in the sugar preferably satisfy the following formulae: 0.4≦(M2/M1)×100, and more preferably 0.5≦(M2/M1)×100. A proportion of the number of moles M3 of xylose in the sugar to the M2 preferably satisfies the following formulae: 0<M3/M2<3, and more preferably O<M3/M2<2.

According to the present invention of the method of producing the cellulose acylate film, it is possible to prolong a continuous manufacturing time of the cellulose acylate film by preventing contamination of the surface of the support. Accordingly, the quality of the cellulose acylate film is maintained and the productivity is improved. The cellulose acylate film obtained by the producing method of the present invention is suitable for a liquid crystal display (LCD).

### BRIEF DESCRIPTION OF DRAWINGS

FIG. 1 is a schematic view showing, a solution casting apparatus used in the present invention.

### BEST MODE FOR CARRYING OUT THE INVENTION

It is preferred to use cellulose acylate as a polymer in the present invention. Acetylation degree of cellulose acylate is preferably in the range of 59.0% to 62.5%, according to the measurement and calculation of acetylation degree by ASTM D-817-91 (a test method for cellulose acetate). The cellulose acylate film with excellent optical property and planarity can be obtained from such cellulose acylate. Nevertheless, the polymer to be used in the present invention can be other than cellulose acylate.

The cellulose acylate used in the present invention contains no contamination precursors or at most 0.05% thereof. That is, it is preferred that 100 g of cellulose acylate contains at most 50 mg of the contamination, more preferably at most 10 mg, and most preferably at most 3 mg. The less the contamination precursors are in 100 g of cellulose acylate, the less the surface of the support is contaminated. If 50 mg or more of the contamination precursors are contained in 100 g of cellulose acylate, the surface of the support is often contaminated, which results in deterioration of film quality and reduction of the productivity because of the necessity to stop the film production to clean the support. The present invention is effective especially when the contamination precursors contain at least one of fatty acid, fatty acid metal salt and fatty acid alcohol, which is more hydrophilic than fatty acid.

A quantity of the contamination precursors in 100 g of the cellulose acylate is obtained by a solvent extraction method stated below. In the solvent extraction method used in the present example cellulose acylate is added in a mixture of a liquid incompatible with the water and the water or liquid having a property of the water (hereinafter, referred to as a hydrophilic liquid), and then the solvent is stirred and left still until the contamination precursors in cellulose acylate are separated and extracted.

[Measuring Method of Quantity of Contamination Precursors (Solvent Extraction Method)]

(1) Cellulose acylate, as a raw material of the film, is crushed to obtain a predetermined amount of crushed cellulose acylate as a sample 1. The predetermined amount of the sample 1 is x1 (mg) and hereinafter referred to as a first sample amount. In order to produce a sample A, a predetermined quantity of acetic acid aqueous solution of predetermined density, as the hydrophilic liquid, is added to the x1 of the sample 1 in a container having a predetermined capacity and then stirred until the sample 1 is completely dissolved. Note that although in the present example the x1 is 50, the container is a 10 litters reagent bottle, acetic acid is 2.5 litters, and the density of the aqueous solution of acetate is 95 wt %, those definitions are for examples only. In addition, a dissolving degree of the sample 1 in the sample A does not matter so long as the chemical affinity of the sample 1 to the acetic acid aqueous solution is different from that to a liquid incompatible with the water stated below, even if the sample 1 is not completely dissolved in the sample A.
(2) In order to obtain a sample B, n-hexane, as a liquid incompatible with the water, is added to the sample A and stirred. A quantity of n-hexane to add is determined in accordance with the x1. In the present example, 1.0 litter of n-hexane is added and the time to stir is for 20 minutes.
(3) Next, the sample B is left still until separating into a water phase and an n-hexane phase. After the separation, the n-hexane phase on top of the water phase is extracted by a separating funnel. The n-hexane is washed once with distilled water, twice with saturated aqueous solution of sodium bicarbonate, and then twice with distilled water. An extracted liquid C is thus obtained. In the present example, the quantity of each of the distilled water and the saturated aqueous solution of sodium bicarbonate for washing the n-hexane solution once is 500 ml, and the separating funnel has a 2-litter capacity.
(4) The extracted liquid C is filtered and concentrated with a concentrating method, in order to obtain a concentrated solution D. In the present example, the filtering is carried out with a glass filter and the concentrating method is a rotary evaporator.
(5) The concentrated solution D is dried to be solid. The solidified substance is further dried by a drying device kept at a predetermined temperature, and then left still to cool down. An extract E is thus obtained, and precisely weighed. The weight of the extract E is referred to as an x2 (mg). In the present example, the concentrated solution D is poured into a weighed aluminum cup when dried and an oven is used as the drying device. Although in the present example the drying is carried out at the temperature in the range of 100° C. to 110° C. for 30 minutes, such conditions can be changed in accordance with the condensed degree of the condensed solution D in the above-stated step (4) and the drying speed for obtaining the extract E.
(6) As a blank test, the above-stated steps (1) to (5) are carried out as steps (7) to (11) using cellulose acylate containing no contamination precursors, so as to obtain weight of an extract x3 (mg).
(12) The content ratio of the contamination precursors in cellulose acylate is calculated by the following formula (I):

Content ratio of Contamination precursors (%)={(x2−x3)×100}/x1 (I)

Cellulose acylate is usually produced by esterification of cellulose obtained from wood pulp or cotton linters with such as acetic anhydride, and cellulose used in the present invention can be obtained from either one of them or a mixture of them. The mixing ratio of wood pulp and cotton linters can be decided arbitrarily. Wood pulp can be obtained from a broadleaf tree and a conifer, and both of them can provide pulp with highly pure cellulose when wood chips of them are pulped with bisulfite solution in high temperature under high pressure. There are differences between the broadleaf tree and the conifer in compositions kinds and/or contents of components and the sizes of the fiber, that is, the fiber of the conifer is thicker and longer than that of the broadleaf tree; nevertheless their cellulose has the same properties and thus either the broadleaf tree or the conifer can be used as a raw material to obtain wood pulp.

In cellulose acylate, it is preferred that the degree of the acyl substitution for hydrogen atoms in hydroxyl groups in cellulose satisfies all of the following formulae:

2.5≦X+Y≦3.0 (I)

0≦X≦3.0 (II)

0≦Y≦2.9 (III)

In the above formulae (I)-(III), the X represents the degree of substitution of the hydrogen atom of the hydroxyl group to the acetyl group, while the Y represents a degree of substitution of the hydroxyl group to the acyl group with 3-22 carbon atoms. Preferably, at least 90 wt. % of cellulose acylate particles have a diameter in the range of 0.1 mm to 4 mm.

Cellulose has glucose units making β-1,4 combination, and each glucose unit has a free hydroxyl group at second, third and sixth positions. Cellulose acylate is a polymer in which a part of or the whole of the hydroxyl groups are esterified so that the hydrogen is substituted by the acyl group with two or more carbons. The degree of substitution for the acyl groups in cellulose acylate means a degree of esterification of the hydroxyl group at each of the second, the third and the sixth positions in cellulose. Accordingly, when the whole (100%) of the hydroxyl group at the same position is substituted, the degree of substitution at this position is 1.

When the degrees of substitution for the acyl groups at the second, third or sixth positions are described as DS2, DS3, DS6, respectively, the total degree of substitution for the acyl groups at those positions (namely, DS2+DS3+DS6) is preferably in the range of 2.00 to 3.00, more preferably in the range of 2.22 to 2.90, and most preferably in the range of 2.40 to 2.82. In addition, DS6/(DS2+DS3+DS6) is preferably in the range of 0.32 to 0.340, more preferably in the range of 0.322 to 0.340, and most preferably in the range of 0.324 to 0.340.

In the present invention, the number of the kind of the acyl groups in cellulose acylate can be one or more. When two or more kinds of acyl groups are in cellulose acylate, it is preferred that one of them is the acetyl group. When a total degree of substitution for the acetyl groups at the second, the third and the sixth positions and that for other acyl groups are described as DSA and DSB, respectively, the value of DSA+DSB is preferably in the range of 2.2 to 2.86, and more preferably in the range of 2.40 to 2.80. In addition, DSB is preferably at least 1.50, and more preferably at least 1.7. In the DSB, the percentage of the substitution on the sixth position is at least 28%. The percentage is preferably at least 30%, more preferably at least 31%, and most preferably at least 32%. Furthermore, the value of DSA+DSB at the sixth position is preferably at least 0.75, more preferably at least 0.80, and most preferably at least 0.85. From such cellulose acylate that satisfies the above conditions, the cellulose acylate solution with excellent dissolubility can be prepared.

The acyl group having at least 2 carbon atoms can be either aliphatic group or aryl group. Such cellulose acylate are, for example, alkylcarbonyl ester, alkenylcarbonyl ester, aromatic carbonyl ester, aromatic alkylcalbonyl ester, and the like. Cellulose acylate may be also esters having other substituents. Preferable substituents are, for example, propionyl group, butanoyl group, pentanoyl group, hexanoyl group, octanoyl group, decanoyl group, dodecanoyl group, tridecanoyl group, tetradecanoyl group, hexadecanoyl group, octadecanoyl group, iso-butanoyl group, t-butanoyl group, cyclohexane carbonyl group, oleoyl group, benzoyl group, naphtylcarbonyl group, cinnamoyl group, and the like. Among them, more preferable groups are propionyl group, butanoyl group, dodecanoyl group, octadecanoyl group, t-butanoyl group, oleoyl group, benzoyl group, naphtyl carbonyl group, cinnamoyl group, and the like. Particularly, propionyl group and butanoyl group are most preferable.

The concentration C1 of Ca in the cellulose acylate solution is preferably at most 100 ppm, more preferably at most 80 ppm, and most preferably at most 70 ppm. Although in the present example the concentration C1 of Ca in the cellulose acylate solution is obtained by measuring an atomic absorption degree of a sample solvent prepared by mixing cellulose acylate in a solution, the present invention is not limited in this method.

### [Measuring Method of Concentration C1 of Ca]

(1) Cellulose acylate is dried to obtain a predetermined quantity y1 (g) of a sample 2. The sample 2 is put in a container having a predetermined capacity. Although the y1 is 3.0 and the container is a porcelain crucible in the present example, the present invention is not limited to them.
(2) The container is heated in a heating device, an electric furnace, at the temperature of 800° C.±50° C. for two hours to carbonize the sample 2. Although the electric furnace and an electric heater and are used in the present example, other methods can be used to carbonize the sample 2.
(3) After the sample 2 is cooled down approximately to a room temperature, a predetermined quantity of hydrochloric acid of a predetermined density is added to the sample 2, stirred, and heated by degrees in the heating device until the sample 2 is dissolved or mixed with hydrochloric acid, in order to obtain a dissolved solution Y. Note that the density and the quantity of the hydrochloric acid are determined in accordance with the y1 (g) of the sample 2.
(4) After it is visually observed that the carbonized sample 2 is completely dissolved or mixed with hydrochloric acid, the dissolved solution Y is cooled down approximately to the room temperature. Then, the dissolved solution Y is poured into another container having a predetermined capacity and diluted with distilled water added thereto making circles, in order to obtain a diluted solution Z. In the present example, the container to contain the dissolved solution Y is a measuring flask having a capacity of 200 ml and the distilled water is added to the dissolved solution Y to obtain 200 ml of the diluted solution Z.
(5) The absorbency of Ca in the diluted solution Z is measured with an atomic absorption spectrophotometer, and the absorbency value is regarded as the concentration C1 (ppm) of Ca in the cellulose acylate solution. The C1 can be also obtained by using an infrared spectrograph to the sample solvent prepared by mixing the carbonized sample 2 in a solution in the same way as stated above.

The C1 depends on the concentration C2 (ppm) of sulfuric acid that generates calcium salt by chemical reaction with calcium ion in the cellulose acylate solution. Accordingly, it is important to know the C2. In the present invention, a proportion of the C1 to the C2 in the cellulose acylate solution satisfies the following formulae: 0.5≦C1/C2≦1.5, more preferably 0.5≦C1/C2≦1.0, and most preferably 0.5≦C1/C2≦0.75. In the present example the C2 in the cellulose acylate solution is obtained by the following method, which is given as an example only.

### [Measuring Method of Concentration C2 of Sulfuric Acid]

(1) In order to prepare absorbent liquid, a mixed indicator of Methyl Red and Methylene Blue is added to 1% of hydrogen peroxide solution and then the hydrogen peroxide solution is neutralized with 0.01 mol/l of NaOH solution until the color of the mixture changes from magenta to faint red.
(2) A tube furnace having an oxygen entry and an absorbing bottle set thereon is heated in the range of 1250° C. to 1350° C.
(3) A combustion boat having 1.0 g of cellulose acylate put thereon to measure the content of sulfuric acid is set close to the inlet of the tube furnace. After 80 ml of the absorbent liquid is poured into the absorbing bottle, one end of a glass tube is inserted into the tube furnace while the other end of it is inserted into the absorbing bottle, such that the tube furnace and the absorbing bottle are connected to each other via the glass tube.
(4) While oxygen is flown into the tube furnace at 2000 ml/min to 2500 ml/min, the combustion boat is gradually inserted into the tube furnace with a quartz stick, so as to carbonize cellulose acylate.
(5) After cellulose acylate is carbonized, the combustion plate is pushed to the center of the tube furnace, such that the carbonized cellulose acylate turns into ash completely. The gas generated until the ashing of cellulose acylate flows into the absorbing bottle via the glass tube.
(6) Supply of oxygen is stopped when the gas stops flowing into the absorbing bottle after the sample is carbonized. The absorbent liquid is poured into a beaker together with distilled water which is poured onto an inner wall of the absorbing bottle to rinse the absorbent liquid off therefrom.
(7) Subsequently, the absorbent liquid is heated by the electric heater to be condensed into 70 ml to 80 ml thereof: Then, a mixed indicator of Methyl Red and Methylene Blue is added to the condensed absorbent liquid and titration with 0.01 mol/l of NaOH solution is carried out. The quantity of the NaOH solution (A ml) is measured when the color of the condensed absorbent liquid containing the mixed indicator and the NaOH solution changes into light orangish yellow.
(8) A blank test is carried out in the same process as described above except for burning the empty combustion boat, and the quantity of the NaOH solution (B ml) required for the titration after heating is measured.
(9) The concentration C2 of sulfuric acid in cellulose acylate is calculated by use of the following formula:

C2 (ppm)=([(A−B)×F×0.048]/W)×[100/(100−M)]

Note that the W, M, and F represent weight of the sample (g), moisture content rate in the sample (%), and a titer for 0.0-1 mol/l of the NaOH solution, respectively.

The concentration of Mg in the cellulose acylate solution is preferably in the range of 5 ppm to 50 ppm, more preferably in the range of 5 ppm to 30 ppm, and most preferably in the range of 5 ppm to 20 ppm. Although in the present example the concentration of Mg is obtained by measuring atomic absorbance, the present invention is not limited to this method.

In the present invention, cellulose is extracted from wood pulp and the total number of moles M1 of all sugar in cellulose acylate and the number of moles M2 of mannose in the sugar satisfy the following formulae: 0.4≦(M2/M1)×100, and more preferably 0.5≦(M2/M1)×100. Furthermore, a proportion of the number of moles M3 of xylose in the sugar to the M2 satisfies the following formulae: 0<M3/M2<3, and more preferably 0<M3/M2<2.

The solvent to dissolve cellulose acylate are, for example, aromatic hydrocarbon (for example, benzene, toluene and the like), halogenated hydrocarbons (for example, dichloromethane, chloroform, chlorobenzene and the like), alcohols (for example methanol, ethanol, n-propanol, n-butanol, diethylene glycol and the like), ketones (for example acetone, methylethyl ketone and the like), esters (for example, methylacetate, ethylacetate, propylacetate and the like), ethers (for example tetrahydrofuran, methylcellosolve and the like) and the like.

The preferable solvent compounds are the halogenated hydrocarbons having 1 to 7 carbon atoms, and dichloromethane is most preferable. In view of physical properties of the cellulose acylate, such as dissolubility, peelability from a support, a mechanical strength of the film, and optical properties, it is preferred to use at least one kind of alcohol having 1 to 5 carbon atoms together with dichloromethane. The content of alcohol is preferably in the range of 2 mass % to 25 mass %, and more preferably in the range of 5 mass % to 20 mass %. Applicable alcohols are, for example, methanol, ethanol, n-propanol, iso-propanol, n-butanol and the like, and especially methanol, ethanol, n-butanol, and a mixture of them are more preferable among them.

Recently, in order to reduce adverse influence on the environment, a solvent containing no dichloromethane is proposed. In this case, the solvent contains ethers with 4 to 12 carbon atoms, ketones with 3 to 12 carbon atoms, esters with 3 to 12 carbon atoms, or a mixture of them. The ethers, ketones, esthers may have a cyclic structure, and a compound having at least two functional groups thereof (—O—, —CO—, —COO—) may be contained in the solvent. The solvent may have other functional groups such as alcoholic hydroxyl groups. In using the solvent having two or more functional groups, the number of carbon atoms should be within a regulation range of the compound having one of the functional groups.

Note that a detailed description about cellulose acylate is provided from [0140] to [0195] in Japanese Patent Laid-Open Publication No. 2005-104148, and a detailed description about the solvents and the additives (such as plasticizers, deterioration inhibitors, optical anisotropy controllers, dyes, matting agents, release agents and the like) for cellulose acylate is provided from [0196] to [0516] of the same publication. Those descriptions are applicable to the present invention.

Having excellent optical property and planarity, the cellulose acylate film produced by the producing method of the present invention is used for a polarizing filter or other members of a liquid crystal display. In view of the protection of the deterioration of them, it is preferred to use a UV-absorbing agent. The preferable UV-absorbing agent is one which is excellent in absorption of UV-rays of at most 370 nm and, for a good quality of display, hardly absorbs visible rays of 400 nm or more. The UV-absorbing agents preferred in the present invention are, for example, oxybenzophenone type compounds, benzotriazol type compounds, salitilic acid ester type compounds, benzophenone type compounds, cianoacrylate type compounds, nickel complex salt type compound and the like.

The following benzotriazol type UV-absorbing agents are preferred, though the present invention is not limited to them. 2-(2′-hydroxy-5′-methylphenyl)benzotriazole; 2-(2′-hydroxy-3′, 5′-di-tert-butylphenyl)benzotriazole; 2-(2′-hydroxy-3′-tert-butyl-5′-methylphenyl)benzotriazole; 2-(2′-hydroxy-3′,5′-di-tert-butylphenyl)-5-chlorobenzotriazole; 2-(2′-hydroxy-3′-(3″,4″,5″,6″-tetrahydrophthalimidomethyl)-5′-methylphenyl)benzotriazole; 2,2-methylenebis(4-(1,1,3,3-tetramethylbutyl)-6-(2H-benzotriazole-2-yl)phenol); 2-(2′-hydroxy-3′-tert-butyl-5′-methylphenyl)-5-chlorobenzotriazole; 2,4-dihydroxybenzophenone; 2,2′-dihydroxy-4-methoxybenzophenone; 2-hydroxy-4-methoxy-5-sulfobenzophenone; bis(2-methoxy-4-hydroxy-5-benzoylphenylmethane); (2,4-bis-(n-octylthio)-6-(4-hydroxy-3,5-di-tert-butylanylino)-1,3,5-triazine; 2-(2′-hydroxy-3′, 5′-di-tert-butylphenyl)-5-chlorobenzotriazole; (2(2′-hydroxy-3′,5′-di-tert-amylphenyl)-5-chlorobenzotriazole; 2,6-di-tert-butyl-p-cresol; pentaerythrityl-tetrakis[3,5-di-tert-butyl-4-hydroxyphenyl]propionate]]; triethyleneglycol-bis[3-(3-tert-butyl-5-methyl-4-hydroxyphenyl)propionate]; 1,6-hexanediol-bis[3-(3,5-di-tert-butyl-4-hydroxyphenyl) propionate]; 2,4-bis-(n-octylthio)-6-(4-hydroxy-3,5-di-tert-butylanilino)-1,3,5-triazine; 2,2-thio-diethylenebis[3-(3,5-di-tert-butyl-4-hydroxyphenyl)propionate]; octadecyl-3-(3,5-di-tert-butyl-4-hydroxyphenyl)propionate; N,N′-hexamethylene-bis(3,5-di-tert-butyl-4-hydroxy-hydrocinnamide); 1,3,5-trimethyl-2,4,6-tris (3,5-di-tert-butyl-4-hydroxybenzyl)benzene; and tris-(3,5-di-tert-butyl-4-hydroxybenzyl)-isocianurate. More preferable agents among them are: (2,4-bis-(n-octylthio)-6-(4-hydroxi-3,5-di-tert-butylanilino)-1,3,5-triazine; 2-(2′-hydroxy-3′,5′-di-tert-butylphenyl)-5-chlorbenzotriazole; 2-(2′-hydroxy-3′,5′-di-tert-amylphenyl)-5-chlorbenzotriazole; 2,6-di-tert-butyl-p-cresol; pentaerythrityl-tetrakis[3-(3,5-di-tert-butyl-4-hydroxyphenyl)propionate]; and triethylene-glycol-bis[3-(3-tert-butyl-5-methyl-4-hydroxyphenyl)propionate]. In addition, the following compound can be used in combination with the above UV-absorbing agents: for example, metallic nonactivator of hydradine type such as N,N′-bis[3-(3,5-di-tert-butyl-4-hydroxyphenyl)propionyl]hydrazine, and processing stabilizers of phosphor type such as tris(2,4-di-tert-butylphenyl)phosphite.

The UV-absorbing agents cited in Japanese Patent Laid-Open Publication No. 06-148430 and No. 07-11056 can be preferably used as well. The UV-absorbing agents of benzotriazole type are preferred in the present invention, since they have high transparency and excellent efficiency in preventing deterioration of the polarizing filter and liquid crystal elements, and is less colored unnecessarily. Although depending on kinds of compounds and conditions, the usual quantity of the UV-absorbing agents to be used for 1 m² of the cellulose acylate film is preferably in the range of 0.2 g to 0.5 g, more preferably in the range of 0.4 g to 1.5 g, and most preferably in the range of 0.6 g to 1.0 g.

Other UV-absorbing agents applicable in the present invention are optical stabilizer shown in a brochure of “Adekastab”, optical stabilizers and UV-absorbing agents in a brochure of Tinuvin of Ciba Specialty Chemicals Inc., SEESORB, SEENOX, SEETEC and the like in the brochure of SHIPRO KASEI KAISHA, LTD, UV-absorbing agents and antioxidants of Johoku Chemical Co., Ltd., VIOSORB of Kyodo Chemical Co., Ltd, and UV-absorbing agents of Yoshitomi Pharmaceutical Ind., Ltd.

The present invention applies a description about spectral transmittance in a UV-wavelength range in Japanese Patent Laid-Open Publication No. 2003-043259. According to the description, the optical film for the polarizing filter and the display device has excellent color reproducibility and endurance against the UV-rays when the spectral transmittance of the film in the UV-wavelength range is in the range of 50% to 95% of UV-wave at 390 nm and at most 5% of UV-wave at 350 nm.

Preferably, the cellulose acylate solution is prepared at the temperature in the range of 0° C. to 150° C., more preferably in the range of 0° C. to 100° C., more preferably in the range of 0° C. to 90° C., and most preferably in the range of 20° C. to 90° C. Although it is preferred not to use a base in preparation of the cellulose acylate solution in the present, invention, either of an organic or an inorganic base can be used in case of using the base. In such a case, however, the organic base is preferably used such as, for example, pyridine and tertiary alkylamine (triethylamine and ethyldiisopropylamine are preferred).

As for the optical properties of the cellulose acylate film of the present invention, retardation values Re and Rth are represented by the following formulae (V) and (VI) and preferably satisfy the following formulae (VII) and (VIII):

Re(λ)=(nx−ny)×d; Formula (V)

Rth(λ)={(nx+ny)/2−nz}×d Formula (VI)

46 nm≦Re(630)≦200 nm; Formula (VII)

70 nm≦Rth(630)≦350 nm; Formula (VIII)

In the above formulae, the Re(λ) and the Rth(λ) represent an in-plane retardation value (unit; nm) at λ nm wavelength and a thickness retardation value (unit; nm) at λ nm wavelength, respectively. The nx, ny, nz and d represent a refractive index in the direction of the slow axis on a film surface, a refractive index in the direction of the fast axis on a film surface, a refractive index in the thickness direction of the film, and a film thickness, respectively.
More preferably, the retardation values satisfy the following formulae (IX) and (X):

46 nm≦Re(630)≦110 nm; Formula (IX)

180 nm≦Rth(630)≦350 nm; Formula (X)

The optical properties such as the retardation values Re, Rth change with variations of a mass and a dimension caused by a change in humidity and a period in high temperature. The less the values Re and Rth change, the better. In order to reduce changes in the optical properties of the values Re,Rth caused by the change in humidity, moisture permeability and equilibrium moisture content in the film are reduced by using cellulose acylate with a large degree of acylation at sixth position and various hydrophobic additives (for example, plasticizer, retardation controller, UV-absorbing agent and the like). The moisture permeability is preferably in the range of 400 g to 2300 g in 1 m² at 60° C. and 95% RH for 24 hours, while the equilibrium moisture content is preferably at most 3.4% at 25° C. and 80% RH. When the relative humidity at 25° C. varies from 10% RH to 80% RH, the retardation values Re,Rth of the optical properties preferably change to at most 12 nm and at most 32 nm, respectively. The quantity of the hydrophobic additives is preferably in the range of 10% to 30%, more preferably in the range of 12% to 25%, and most preferably in the range of 14.5% to 20% with respect to cellulose acylate. When the additives are volatile or degradable, the mass and size of the film are changed and, as a result, the optical property of the film is changed. Accordingly, the mass variation of the film is preferably at most 5% after 48 hours at 80° C. and 90% RH, and the size variation of the film is preferably at most 5% after 24 hours at 60° C. and 95% RH. The photoelastic coefficient is preferably at most 50×10⁻¹³ cm²/dyne, since the optical property changes less when the film has a small photoelastic coefficient, regardless of some variations in the size and the mass.

The following description explains producing method of the cellulose acylate solution used to produce the cellulose acylate film in the present invention, but this is not the only method. A first additive liquid is prepared by adding cellulose acylate and the plasticizers (for example, triphenylphosphate, biphenyldiphenylphosphate, and the like) to a portion of a mixed solvent of dichloromethane as the main solvent, and alcohols, and stirring the solvent to dissolve. The dissolubility of cellulose acylate can be enhanced by heating or cooling the solvent. Next, a portion of the mixed solvent and the UV-absorbing agent (preferably, for example, benzotriazol type compound) are mixed together and dissolved to obtain a second additive liquid. Then, in order to obtain a third additive liquid, a portion of the mixed solvent and a matting agent such as silica particles are mixed together and distributed. In accordance with the object, it is possible to prepare other additive liquid containing the deterioration inhibitors, optical anisotropy controlling agent, a dye, and a peeling agent, respectively.

After preparing a mixed additive liquid by mixing the first to the third additive liquids and stirring it, the mixed additive liquid is filtered by a filtration apparatus to remove impurities. The filtered solution is used as the cellulose acylate solution to produce the film. Preferably, filtration is carried out once or more with the filter having pores, which average diameter is at most 100 μm, and at least at 50 L/hr. It is preferred to remove foam from the first to third additive liquids and the cellulose acylate solution by any known method.

Details about methods for dissolving, filtering, removing foam and adding raw materials and additives are explained from [0517] to [0616] in Japanese Patent Laid-Open Publication No. 2005-104148, and they are applicable to the present invention as well.

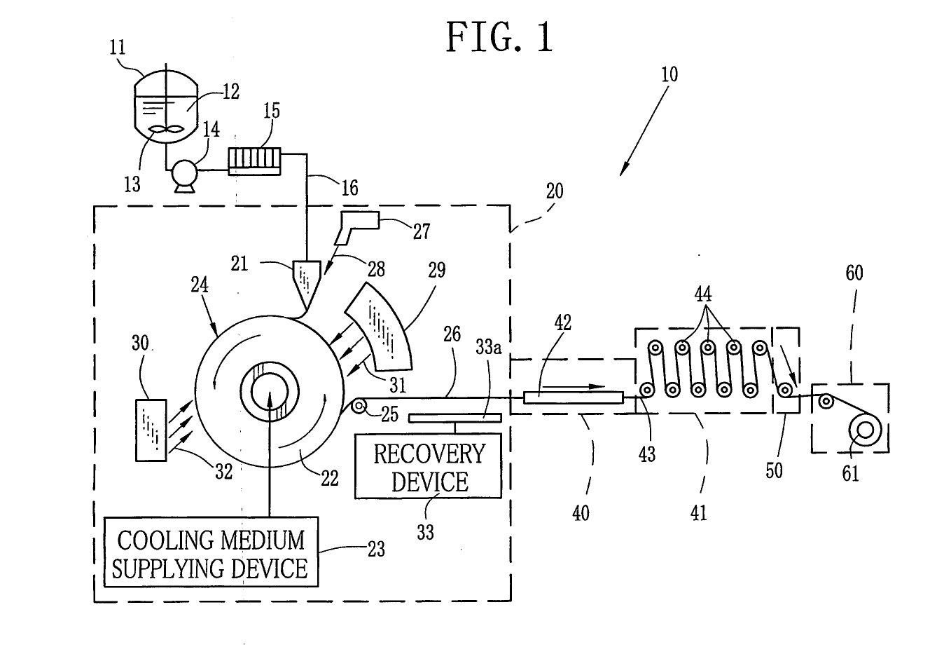

As shown in FIG. 1, in a film producing apparatus 10 a mixing tank 11 contains a mixed additive liquid 12 prepared in the above method and stirred to uniform the composition. The mixed additive liquid 12 is fed to a filtration apparatus 15 through a pump 14 and filtered to obtain a cellulose acylate solution 16 by removing impurities. The cellulose acylate solution 16 is fed at a predetermined flow volume to a casting die 21 in a casting chamber 20 and then onto a rotary drum 22. The rotary drum 22 is provided with a support rotary shaft (not shown) having a roller bearing and rotates when put on a casing body (not shown). A casting channel (not shown) is provided inside the support rotary shaft and the rotary drum 22, and the rotary drum 22 is cooled down when a cooling medium is supplied from a cooing medium supplying device 23 to the casting channel. Note that the rotary drum whose surface is cooled down by the cooling medium is hereinafter referred to as a cold drum.

The cooling medium are of, for example, a glycol type, a fluorine type, or alcohol type, and Fluorinert™ FC-77, HFE7100, and Coldbrine™ FP60 are preferable, although not limited to them. Other than by supplying the cooling medium, the cold drum 22 can be cooled down at a predetermined temperature by blowing air directly to the cold drum 22 from a fan disposed inside the casting chamber 20. The method to cooling down the cold drum 22 is not particularly limited. In addition, the cold drum 22 is preferably made of a material having endurance against low temperature, so as not to decline in strength against impact and repeated loading. Such a material can be SUS, SLA, STPL, and the like.

When cooled down on the cold drum 22, the cellulose acylate solution 16 obtains a self-supporting property and becomes a casting film 24. The casting film 24 is continuously peeled off at a peeling line (not shown) from the cold drum 22 by a peeling roller 25 to form a wet film 26 containing the solution. It is preferred to provide a fan (not shown), for example, under the peeling roller 25, to blow drying air in the direction opposite to the rotating direction of the cold drum 22 toward the wet film 26 when the wet film 26 is peeled off from the cold drum 22. In addition, a drawing force (a film stress), applied to the casting film 24 along the feeding direction when the wet film 25 is peeled off from the cold drum 22, is preferably at least 450 MPa, more preferably at least 600 MPa, and most preferably at least 750 MPa. Although a load transducer is used in the present invention, the method to apply the drawing force to the casting film 24 is not limited in it.

It is disclosed in Japanese Patent Application No. 2003-071863 that in order to obtain a fine film the temperature of the surface of the cold drum is kept at 6° C. when the film is peeled off from a belt rotated by the cold drum, and that the period of time for the film to stay on the belt is for 0.5 to 20 seconds. More preferable conditions disclosed in the application are: a dew point when peeling off the film from the belt is 7° C. at most, a part of the belt where the film is peeled off therefrom reaches a casting point of a dope within a period of 0.5 to 30 seconds, most preferably within the period of 1 to 10 seconds, the surface of the cold drum is kept at in the range of 7° C. to 15° C., the film stayed on the cold drum for the period of 1.5 to 12 seconds, and the film is peeled off within the period of 30 to 900 seconds after film casting. Those conditions are applicable to the present invention.

A first gas blowing device 27 having a gas tube (not shown) is disposed behind the casting die 21. The first gas blowing device 27 blows a first gas 28, which is preferably, for example, inactive gas such as nitrogen gas and helium gas, so as not to have influence on the casting film 24. The first gas 28 lowers the concentration of gas in the air behind the casting die 21 and thus prevents the generation of dew on the surface of the cold drum 22 caused when the gas there is cooled down and liquefied. As a result, generation of a wrinkle and a twitch on the casting film 24 is prevented. Note that it is preferred that the first gas 28 is in the range of 30° C. to 50° C. in temperature and in the range of 0.5 m/sec to 2 m/sec in wind velocity.

A second gas blowing device 29 and a third gas blowing device 30 are also provided to blow gas at the cold drum 22 for the purpose of preventing the dew generation on the cold drum 22. The second gas 31 from the second gas blowing device 29 is preferably in the range of 50° C. to 100° C. in temperature and in the range of 2 m/sec to 10 m/sec in wind velocity, while the third gas 32 from the third gas blowing device 30 is preferably in the range of 20° C. to 30° C. in temperature and in the range of 2 m/sec to 10 m/sec in wind velocity. Although the gas 28, 31 and 32 are not strictly limited to the above conditions, each of them at lower wind velocity than the above are less effective in reducing the density of the gas in the vicinity of the casting film 24, while generating uneven wind which deteriorates quality of the casing film 24 at higher wind velocity than the above. Note that each of the second and the third gas blowing devices 29 and 30 can be disposed other places than shown in FIG. 1.

In order for the casting film 24 to be smoothly peeled off from the cold drum 22, the difference in surface tension of the cold drum 22 and that of the cellulose acylate solution 16 is at least 3×10⁻² N/m. When this condition is satisfied, the cold drum 22 hardly gets wet with the solvent and the contact area between the casting film 24 and the cold drum 22 is reduced. As a result, the force necessary to peel off the film can be reduced and thus the film can be stably peeled off. Note that any known method can be used to measure the surface tension.

In order to obtain the wet film 26 with excellent planarity having no the wrinkle and the twitch, it is preferred that the casting die 21 and the cold drum 22 are disposed within the casting chamber 20 in order to avoid exposing the casting film 24 to random wind. In addition, it is preferred to provide a recovery device 33 for condensing and collecting vaporized solvent in the casting chamber 20, since the dew in the casting chamber 20 can adhere to the casting film 24 and thereby causes a line on the casting film 24 or condense on the rotary shaft and the roller bearing (not shown) connected to the cold drum 22 and thereby causes trouble in controlling the rotating number of the cold drum 22. Furthermore, it is preferred to provide the recovery device 33 with a condensation surface 33a for condensing moisture in the air and the vaporized solvent from the casting film 24 in the casting chamber 20. The temperature of the condensation surface 33a is determined in accordance with the kind of the solvent composing the cellulose acylate solution 16.

The wet film 26 is fed to a tenter device 40 on the downstream side of the casting chamber 20 to be dried once, and then to a drying chamber 41 on the further downstream side to be dried again. A plurality of rollers (not shown) are provided in the tenter device 40, and the wet film 26 is conveyed by the rollers while dried by drying air at a predetermined temperature, preferably in the range of 20° C. to 250° C., blown from a tenter dryer 42. In the tenter device 40 both sides of the wet film 25 is nipped by clips to stretch in the longitudinal direction thereof. The wet film 25 thus obtains planarity of the surface thereof.

The wet film 25 is dried in the tenter device 40 until the solvent in the wet film 25 is reduced to a predetermined content, and then regarded as a film 43 when fed to the drying chamber 41. Both longitudinal edges of the film 43 are cut by an edge slitting device (not shown) disposed between the tenter device 40 and the drying chamber 41. Although this cutting process can be omitted, the process is preferably carried out anytime between the casting process and completion of the film producing. In the drying chamber 41 a plurality of rollers 44 and a fan (not shown) are provided, and the film 43 is advanced on the rollers while dried by the drying air at a predetermined temperature from the fan.

Next, the film 43 is fed into a cooling chamber 50 to be cooled down to the room temperature. Note that a moisture conditioning chamber (not shown) can be provided between the drying chamber 41 and the cooling chamber 50 to blow the air at controlled moisture and temperature, so as to prevent defective winding of the film 43.

The film 43 is then fed into a winding chamber 60 and wound about a winding shaft 61. Preferably, a predetermined tension is applied to the film 43 by a press roller (not shown) while the film 43 is being wound, and the tension is gradually changed from a start to an end of the winding. It is preferred that the film 43 wound about the winding shaft 61 has a length of at least 100 m and a width of at least 600 mm, more preferably 1400 mm to 1800 mm. Note that the film 43 is not necessarily wound about the winding shaft 61 but can take other forms such as a sheet of the film. It is also possible to provide a knurling with the film 43 anytime between drying process for the wet film 25 and the completion of the film producing.

The solution casting method of the present invention is suitable for producing the film with a thickness in the range of 20 μm to 120 μm. The thickness of the film is more preferably in the range of 20 μm to 65 μm, and most preferably in the range of 20 μm to 45 μm.

The cellulose acylate film produced by the method of the present invention is effectively used as a protective film particularly for a polarizing filter. In a liquid crystal display, two polarizing filters, in which the cellulose acylate films are attached to a polarizer, are adhered to a liquid crystal layer. Note that the polarizing filter can be disposed in an arbitrary position. Details about the liquid crystal displays of TN type, STN type, VA type, OCB type, reflective type, and other types are described in Japanese Patent Laid-Open Publication No. 2005-104148, which are applicable to the present invention. The description from [1088] to [1265] of this publication explains usages of the cellulose acylate films provided with an optically anisotropic layer and with antireflective and antiglare functions, and optically biaxial cellulose acylate film provided with adequate optical properties to function as an optical compensation film. This description is applicable to the present invention.

Although FIG. 1 shows an example in which one kind of the cellulose acylate solution is cast to form a single layer, the present invention is not limited to it but applicable to, for example, a co-casting method in which plural cellulose acylate solutions are supplied into a feed block provided on the upstream side of the casting die 21 and then mixed together when cast. In addition, although FIG. 1 shows a solution casting method of the endless band type, the present invention is also applicable to a solution casting method of endless band type in which the cellulose acylate solution is cast onto an endless band continuously rotating on rollers.

In the solution casting method of the present invention, the co-casting method is applied to cast more than one cellulose acylate solutions in sequence or at the same time. When plural cellulose acylate solutions are cast at the same time, it is possible to use either the casting die having a feed block mounted thereon or a multi-manifold type casting die. The film produced by the co-casing method has multi-layered structure, and the thickness of the top layer or the bottom layer is preferably in the range of 0.5% to 30% of the total film thickness.

### [Properties and Measuring Method]

Details about properties and measuring method of the cellulose acylate film wound about the winding shaft are described from to [1087] of Japanese Patent Laid-Open Publication No. 2005-104148, and those description are applicable to the present invention.

[Surface Treatment]

When a laminated film is produced by laminating the cellulose acylate film on a different film, it is preferred that at least one side of the cellulose acylate film is preliminarily treated. The preferable surface treatment is at least one of vacuum glow discharge, plasma discharge under the atmospheric pressure, UV-light irradiation, corona discharge, flame treatment, acid treatment and alkali treatment.

It is preferred that the cellulose acylate film in the laminated film having surface treatment contains at least one kind of each of surfactants, lubricants and matting agents in the range of 0.1 mg/m² to 1000 mg/m² each. More preferably, the layer contains at least one kind of antistatic agents in the range of 1 mg/m² to 1000 mg/m². Methods for forming functional layers are described in detail from [0890] to [1072] of Japanese Patent Laid-Open Publication No. 2005-104148, which are applicable to the present invention.

Examples of the present invention are described below, but note that the present invention is not limited to them. The conditions of the Example 1 are described in detail, but explanations about the conditions of other examples same as those of the Example 1 are omitted. Table 1 shows the conditions and results of the examples. In Table 1 and the explanations below, Conditions 1 is quantity of contamination precursors (mg) in 100 g of cellulose acylate, Condition 2 is the concentration C1 (ppm) of Ca in the cellulose acylate solution, and Condition 3 is a proportion of the C1 to the concentration C2 (ppm) of sulfuric acid in the cellulose acylate solution. In addition, Condition 4 is the concentration of Mg (ppm) in the cellulose acylate solution, Condition 5 is a percentage (mol %) of the number of moles M2 of mannose in the total number of moles M1 of all sugar in the cellulose acylate, and Condition 6 is the proportion of the number of moles M3 of xylose in the sugar to the M2.

[Preparation of Cellulose Acylate Solution]

The mixed additive liquid 12 is prepared by mixing raw materials and stirring the mixed raw materials to dissolve with a mixing blade 13 in the mixing tank 11. The raw materials are cellulose triacetate, methyl acetate, acetone, methanol, ethanol, butanol, plasticizer A (ditrimethylolpropanetetra acetate), plasticizer B (triphenyl phosphate), UV agent a (2,4-bis-(n-octylthio)-6-(4-hydroxy-3,5-di-tert-butylanilino)-1,3,5-triazine), UV agent b (2-(2′-hydroxy-3′,5′-di-tert-butylphenyl)-5-chlorobenzotriazole), UV agent c (2-(2′-hydroxy-3′,5′-di-tert-amylphenyl)-5-chlorbenzotriazole,)), release agent a (C₁₂H₂₅OCH₂CH₂O—P(═O)—(OK)₂), and release agent b (citric acid), fine particles (silicon dioxide (particle diameter: 20 nm, Mohs hardness: 7)). Subsequently, the cellulose acylate solution 16 is obtained by filtering the mixed raw materials by means of the filtration device 15.

### Example 1

| Condition 1 | 3.2 mg |
|---|---|
| Condition 2 | 66 ppm |
| Condition 3 | 0.69 |
| Condition 4 | 23 ppm |
| Condition 5 | 1.2 mol % |
| Condition 6 | 1.1 |

The film 26 is produced by the film producing apparatus 10 from the cellulose acylate solution 16 prepared based on the above conditions 1-6. The casting die 21 is in the shape of a coat hanger. The cold drum 22 has a mirror finished surface to have 0.04 μm of a surface roughness Rs. The surface temperature of the cold drum 22 is kept at −20° C. by supplying the cold drum 22 with the cooling medium from the cooling medium supplying device 23. The cellulose acylate solution 16 is cast from the casting die 21 onto the cold drum 22, while the first to the third gas 28, 31 and 32 are blown from the first to the third gas blowing devices 27, 29 and 30, respectively. Then the casting film 24 is dried by the third gas 32 blown from the third gas blowing device 30 while continuously peeled off from the cold drum 22 by the peeling roller 25, and the wet film 26 is thus obtained. The wet film 26 is fed to the tenter device 40 to be dried therein, and the film 43 is thus obtained. The film 43 is fed to the drying chamber 41 having a plurality of rollers 44 to be dried more, and then cooled down to the room temperature in the cooling chamber 50. The film 43 is then wound about the winding shaft 61 in the winding chamber 60. The thickness of the film 43 at this point is 80 μm.

### Example 2, 3

A film is produced by the film producing apparatus 10 under the same conditions as Example 1 except for the Condition 1.

### Example 4, 5

Another is produced by the film producing apparatus 10 under the same conditions as Example 1 except for the Condition 2.

### Example 6, 7

Another is produced by the film producing apparatus 10 under the same conditions as Example 1 except for the Condition 3.

### Example 8, 9

The film is produced by the film producing apparatus 10 under the same conditions as Example 1 except for the Condition 4.

### Example 10, 11

The film is produced by the film producing apparatus 10 under the same conditions as Example 1 except for the Condition 5.

### Example 12

The film is produced by the film producing apparatus 10 under the same conditions as Example 1 except for the Condition 6.

TABLE 1

| | Condition 1 | | | | | | | |
|---|---|---|---|---|---|---|---|---|
| | Quantity of | Condition 2 | | Condition 4 | Condition 5 | | Evaluation | |
| | contamination | Concentration 1 | Condition 3 | Concentration | (M2/M1) × | Condition 6 | | Contamination |
| | precursors | of Ca | C1/C2 | of Mg | 100 | M3/M2 | Quality | on drum |
| | (mg) | (ppm) | (—) | (ppm) | (mol %) | (—) | Stability | surface |
| Example 1 | 3.2 | 66 | 0.69 | 23 | 1.2 | 1.1 | A | P |
| Example 2 | 60 | 60 | 0.56 | 21 | 0.9 | 1.0 | A | F |
| Example 3 | 51 | 66 | 0.69 | 23 | 1.2 | 1.1 | A | F |
| Example 4 | 3.2 | 110 | 0.69 | 23 | 1.2 | 1.1 | A | F |
| Example 5 | 3.2 | 152 | 0.69 | 23 | 1.2 | 1.1 | C | F |
| Example 6 | 5.6 | 22 | 0.43 | 21.5 | 0.9 | 1.2 | A | P |
| Example 7 | 5.6 | 22 | 1.6 | 21.5 | 0.9 | 1.2 | B | F |
| Example 8 | 5.0 | 32 | 0.58 | 55 | 0.9 | 1.2 | A | F |
| Example 9 | 5.0 | 32 | 0.58 | 3 | 0.9 | 1.2 | A | F |
| Example 10 | 5.0 | 32 | 0.58 | 23 | 0.3 | 1.2 | A | F |
| Example 11 | 5.0 | 32 | 0.58 | 23 | 0.41 | 1.2 | A | P |
| Example 12 | 4.0 | 50 | 0.65 | 22 | 1.1 | 3.2 | B | F |

[Method for Evaluating Result]

Contaminated degrees on the drum surface and quality stability of the film are evaluated by the following methods.

[Method for Evaluating Contamination Degrees of Drum Surface]

Visual observation of the surface of the cold drum 22 is carried out for each example after 120 hours from the start of the film producing. An “F” (Failure) in Table 1 indicates that the surface of the cold drum 22 is contaminated, while a “P” (Pass) indicates that the surface of the cold drum 22 is not contaminated.

[Method for Evaluating Quality Stability of Film]

Each films is cut into a sheet of 30 m×40 m as a sample after 120 hours from the completion of the film producing. The retardation value of each sample is measured and based on the retardation value birefringence in the thickness direction of each sample is calculated. Based on the birefringence the quality stability of the film is evaluated in three levels: excellent quality (A), slightly inferior but usable (B), and not good and not usable (C).

[Influence of Contamination Precursors]

In Examples 1-3, films are produced from the cellulose acylate solutions containing different quantity of the contamination precursors in 100 g of the cellulose acylate solution. The quality stability of the films is excellent (A) in any of the Examples 1-3, while it is observed that the surface of the drum of the Example 1 is not contaminated (P) but the surfaces of the drums of the Examples 2 and 3 are contaminated (F). In addition, the surface of the drum of the Example 2 is more contaminated than that of the Example 3. Accordingly, it is found that the contamination of the surface of the drum is influenced by the contamination precursors, and that, in order to prevent contamination of the drum surface, the quantity of the contamination precursors in 100 g of cellulose acylate is preferably at most 50 mg, that is, cellulose acylate preferably contains the contamination precursors at most 0.05% thereof.

[Influence of Concentration of Ca]

In Examples 1, 4 and 5, films are produced from the cellulose acylate solutions containing different concentration of Ca in the cellulose acylate solutions. The quality stability of the films is excellent (A) in the Examples 1 and 4 but not good and not usable (C) in the Example 5. It is observed that the surface of the drum of Example 1 is not contaminated (P) but the surfaces of the drums of Examples 4 and 5 are contaminated (F). In addition, the surface of the drum of the Example 5 is more contaminated than that of Example 4. Accordingly, it is found that the concentration of Ca in the cellulose acylate solution has an influence on the contamination of the surface of the drum and is preferably at most 100 ppm, in order to prevent contamination of the drum surface.

[Influence of Concentration of Ca and Sulfuric Acid]

In Examples 1, 6 and 7, films are produced from the cellulose acylate solutions containing different proportions of the concentration of Ca to the concentration of sulfuric acid. The quality stability of the films is excellent (A) in the Examples 1 and 6, while slightly inferior but usable (B) in the Example 7. It is observed that the surfaces of the drums of Example 1 and 6 are not contaminated (P) but the surface of the drum of Example 7 is contaminated (F). The conditions of Example 6 and Example 2 are approximately the same. Accordingly, it is found that the proportion of the concentration of Ca to the concentration of sulfuric acid in the cellulose acylate solution has an influence on the contamination of the surface of the drum and that, in order to prevent contamination of the drum surface, it is preferred the following formula is satisfied:

0.5≦C1/C2≦1.5.

[Influence of Concentration of Mg]

In Examples 1, 8 and 9, films are produced from the cellulose acylate solution containing different concentration of Mg in the cellulose acylate solutions. The quality stability of the films is excellent (A) in any of the Examples 1, 8 and 9. It is observed that the surface of the drum of Example 1 is not contaminated (P) but the surfaces of the drums of Example 8 and 9 are contaminated (F). Accordingly, it is found that the concentration of Mg in the cellulose acylate solution has an influence on the contamination of the surface of the drum and is preferably in the range of 5 ppm to 50 ppm in the cellulose acylate solution, in order to prevent contamination of the drum surface.

### INDUSTRIAL APPLICABILITY

The method for producing a cellulose acylate film of the present invention is applicable to a production of the cellulose acylate film for optical application in a device such as an LCD.

1. A method for producing a cellulose acylate film comprising the steps of:
preparing a cellulose acylate solution by dissolving cellulose acylate in a solvent, a concentration of a compound in said cellulose acylate is 0% or at most 0.05% to be extracted to a liquid incompatible with the water in a mixture of said liquid and the water;
casting a cellulose acylate solution onto a support running continuously to form a casting film;
peeling off said casting film as a film from said support; and
drying said film by a drying device while said film being advanced.

2. A method as defined in claim 1, wherein acetylation degree of said cellulose acylate is in the range of 59.0% to 62.5%.

3. A method as defined in claim 1, wherein said compound is at least one of fatty acid, fatty acid metal salt, and fatty acid alcohol.

4. A method as defined in claim 3, wherein a concentration C1 of Ca in said cellulose acylate solution is at most 100 ppm.

5. A method as defined in claim 4, wherein a proportion of said concentration C1 to a concentration C2 of sulfuric acid in said cellulose acylate solution satisfies the following formula:
0.5≦C1/C2≦1.5.

6. A method as defined in claim 5, wherein a concentration of Mg in said cellulose acylate solution is in the range of 5 ppm to 50 ppm.

7. A method as defined in claim 6, wherein said cellulose acylate is obtained from pulp wood, and the total number of moles M1 of all sugar in said cellulose acylate and the number of moles M2 of mannose in said sugar satisfy the following formula:
0.4≦(M2/M1)×100.

8. A method as defined in claim 7, wherein a proportion of the number of moles M3 of xylose in said sugar to said M2 satisfies the following formula:
0<M3/M2<3.
